(19) United States
(12) Patent Application Publication
(10) Pub. No.: US 2026/0078636 A1
(43) Pub. Date: Mar. 19, 2026

(54) ANCHOR DEVICE FOR AN OPERATING ELEMENT AND WINDOW SHADE INCLUDING THE SAME

(71) Applicant: Teh Yor Co., Ltd., New Taipei City (TW)

(72) Inventor: Chung-Chen HUANG, New Taipei City (TW)

(73) Assignee: Teh Yor Co., Ltd., New Taipei City (TW)

(21) Appl. No.: 19/316,429

(22) Filed: Sep. 2, 2025

Related U.S. Application Data
(60) Provisional application No. 63/696,129, filed on Sep. 18, 2024.

(51) Int. Cl. E06B 9/324

(52) U.S. Cl. CPC E06B 9/324

(57) ABSTRACT

An anchor device for an operating element of a window shade includes a casing having a passage of an operating element, a first holding part movably connected to the casing and having a first engaging portion adapted to engage with the operating element, and a second holding part movably connected to the casing and having a second engaging portion adapted to engage with the operating element. The first engaging portion and the second engaging portion are operable to engage with the operating element so that the anchor device holds on to the operating element, and are placed away from each other to release the operating element for movement of the operating element through the anchor device.

### CROSS-REFERENCE TO RELATED APPLICATION(S)

This application claims priority to U.S. provisional Ser. No. 63/696,129 filed on Sep. 18, 2024, the disclosure of which is hereby incorporated by reference.

### BACKGROUND

### 1. Field of the Invention

The present invention relates to window shades, in particular to an anchor device for an operating element of a window shade.

### 2. Description of the Related Art

Window shades are installed in homes to provide shading and privacy or for decorative purposes. Many window shades available on the market include operating cords operable to open and close a shading structure. However, the suspended operating cord easily swings, and may inadvertently wrap around the neck of a child and cause injury.

Therefore, there is a need for a device that can restrict the operating cord of a window shade and address at least the foregoing issues.

### SUMMARY

The present application describes an anchor device for an operating element of a window shade that can address at least some of the aforementioned issues.

According to one aspect, the anchor device includes a casing having a passage of an operating element, a first holding part movably connected to the casing and having a first engaging portion adapted to engage with the operating element, and a second holding part movably connected to the casing and having a second engaging portion adapted to engage with the operating element. The first engaging portion and the second engaging portion are operable to engage with the operating element so that the anchor device holds on to the operating element, and are placed away from each other to release the operating element for movement of the operating element through the anchor device.

According to another aspect, the present application provides a window shade including the aforementioned anchor device.

### BRIEF DESCRIPTION OF THE DRAWINGS

FIG. 1 is a perspective view illustrating an embodiment of an anchor device for an operating element of a window shade;

FIG. 2 is an exploded view of the anchor device shown in FIG. 1;

FIG. 3 is a cross-sectional view of the anchor device shown in FIG. 1, wherein a first holding part of the anchor device is shown in a hold state;

FIG. 4 is a cross-sectional view of the anchor device shown in FIG. 1, wherein the first holding part of the anchor device is shown in a release state;

FIG. 5 is a perspective view illustrating further construction details of the first holding part and a second holding part provided in the anchor device of FIG. 1, wherein the second holding part is shown in an unlocking position;

FIG. 6 is a perspective view illustrating the second holding part of the anchor device in a locking position;

FIG. 7 is a perspective view illustrating the second holding part in the unlocking position and the first holding part in the release state;

FIGS. 8-10 are rear views of the anchor device shown in FIG. 1;

FIG. 11 is a cross-sectional view illustrating a displacement of a second engaging portion of the second holding part for pressing an operating element against a first engaging portion of the first holding part in the anchor device shown in FIG. 1;

FIG. 12 is a perspective view illustrating a construction of a fixing part for affixing the anchor device to a support surface;

FIG. 13 is an exploded view illustrating the anchor device and the fixing part shown in FIG. 12;

FIG. 14 is a front view illustrating the fixing part of FIG. 12 engaged with the anchor device;

FIG. 15 is a perspective view illustrating exemplary use of the anchor device with a window shade;

FIG. 16 is a perspective view illustrating exemplary operation of the window shade while the anchor device is not affixed to a fixed support surface;

FIG. 17 is a schematic view illustrating how the anchor device of FIGS. 1 and 2 is affixed to a support surface;

FIG. 18 is a schematic view illustrating how the anchor device of FIGS. 12-14 is affixed to a support surface;

FIG. 19 is a perspective view illustrating a variant embodiment of the anchor device coupled to a bead chain provided as the operating element of the window shade;

FIG. 20 is an exploded view of the anchor device shown in FIG. 19;

FIGS. 21 and 22 are cross-sectional views respectively illustrating the first holding part of the anchor device shown in FIG. 20 in the hold state and the release state;

FIG. 23 is a perspective view illustrating the second holding part of the anchor device shown in FIG. 20 in the unlocking position;

FIGS. 24 and 25 are respectively a perspective and a cross-sectional view illustrating the second holding part of the anchor device shown in FIG. 20 in the locking position; and

FIG. 26 is an exploded view illustrating a variant construction of the fixing part used for affixing the anchor device shown in FIGS. 19 and 20 to a support surface.

### DETAILED DESCRIPTION OF THE EMBODIMENTS

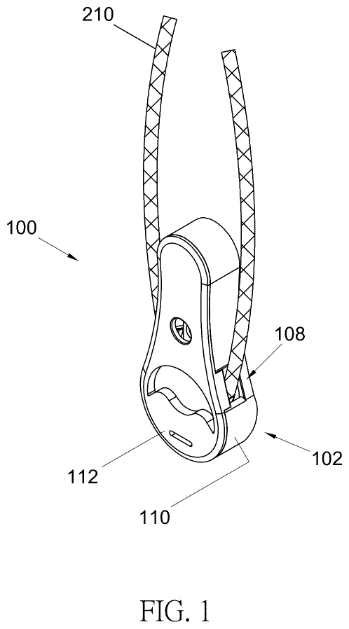

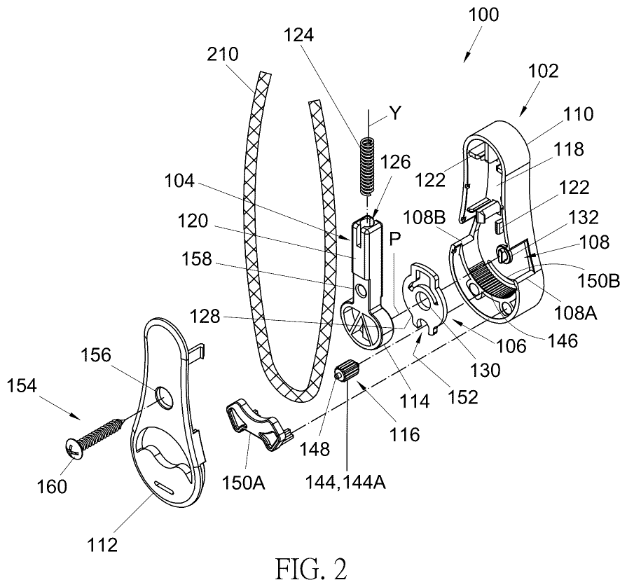

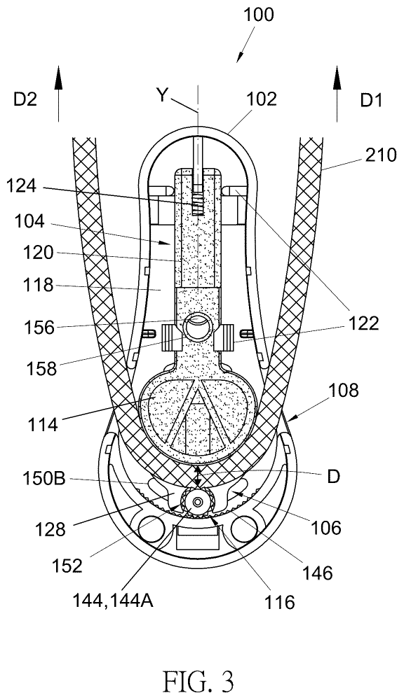

FIG. 1 is a perspective view illustrating an anchor device 100 for an operating element 210 of a window shade, FIG. 2 is an exploded view of the anchor device 100, and FIG. 3 is a cross-sectional view of the anchor device 100. The anchor device 100 may be suitable for use with an operating member of a window shade. Examples of an operating member provided in a window shade can include, without limitation, a cord, a string, a ribbon, a bead chain, a strip, and like elongate and flexible operating members. The anchor device 100 is operable to anchor the operating element 210 to a fixed support surface, e.g., a wall in a house. Once the anchor device 100 anchors the operating element 210 at a fixed position on the support surface, the operating element 210 does not freely hang from the window shade, which can prevent accidental wrapping of the operating element 210 around the neck of a child.

Referring to FIGS. 1-3, the anchor device 100 includes a casing 102, and a first and a second holding part 104 and 106 movably connected to the casing 102.

The casing 102 has a passage 108 for the operating element 210. More specifically, the casing 102 can have a hollow interior in which are disposed the first and the second holding part 104 and 106, and the passage 108 can communicate with the hollow interior of the casing 102. The operating element 210 is disposed so as to be movable along the passage 108 and extend between the first holding part 104 and the second holding part 106 inside the casing 102.

The casing 102 can have any suitable shapes, which may include, without limitation, elongate shapes, rectangular shapes, square shapes, rounded shapes, etc. According to an example of construction, the casing 102 can include a casing body 110 having a hollow interior, and a cover 112 fixedly connected to the casing body 110 to at least partially close the casing body 110. The passage 108 can include two openings 108A and 108B provided in the casing body 110, and the operating element 210 can enter and exit the casing 102 through the openings 108A and 108B.

The first holding part 104 and the second holding part 106 are disposed inside the casing 102 adjacent to the passage 108, and are movably connected to the casing 102. Each of the first holding part 104 and the second holding part 106 has an engaging portion adapted to engage with the operating element 210, i.e., a first engaging portion 114 for the first holding part 104 and a second engaging portion 116 for the second holding part 106. The first engaging portion 114 and the second engaging portion 116 are spaced apart from each other inside the casing 102. The operating element 210 can extend through a region between the first engaging portion 114 and the second engaging portion 116, and can contact with one or both of the first engaging portion 114 and the second engaging portion 116. The first engaging portion 114 of the first holding part 104 and the second engaging portion 116 of the second holding part 106 are operable to engage with the operating element 210 so that the anchor device 100 holds on to the operating element 210, and are placed away from each other to release the operating element 210 for movement of the operating element 210 through the anchor device 100.

The first holding part 104 and the second holding part 106 may be configured to move in various ways relative to the casing 102 to hold and release the operating element 210. According to an example of construction, at least one of the first holding part 104 and the second holding part 106 may be configured to slide or rotate relative to the casing 102. For example, the first holding part 104 may be configured to slide relative to the casing 102, and the second holding part 106 may be configured to rotate relative to the casing 102.

According to an example of construction, the casing 102 can have a casing wall 118 delimiting at least partially the hollow interior of the casing 102, and the first holding part 104 and the second holding part 106 are disposed in the hollow interior of the casing 102 for moving parallel to the casing wall 118. For example, the first holding part 104 may be configured to slide parallel to the casing wall 118, and the second holding part 106 may be configured to rotate parallel to the casing wall 118.

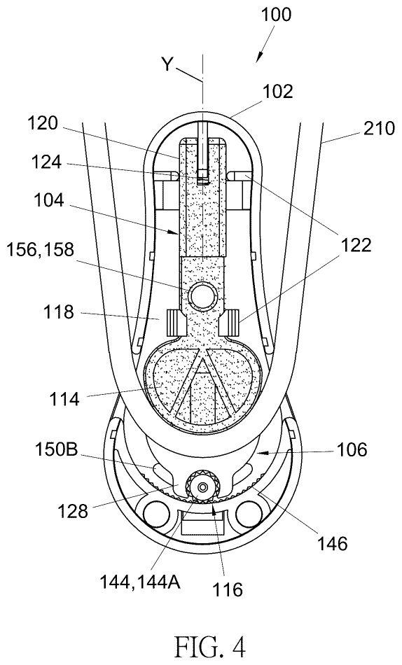

Referring to FIGS. 1-3, the first holding part 104 is configured to move relative to the casing 102 and the second holding part 106 between a hold state and a release state. The hold state is shown in FIG. 3, and FIG. 4 is a cross-sectional view illustrating the first holding part 104 in the release state. The first holding part 104 is movable from the release state to the hold state to urge a portion of the operating element 210 against the second engaging portion 116 of the second holding part 106 so that the operating element 210 is engaged with both the first engaging portion 114 of the first holding part 104 and the second engaging portion 116 of the second holding part 106. In the hold state, the anchor device 100 holds on to the operating element 210 such that the operating element 210 is prevented from sliding through the casing 102 of the anchor device 100. The anchor device 100 thus can move along with the operating element 210, e.g., as the operating element 210 is operated by a user.

The first holding part 104 is movable from the hold state to the release state to displace the first engaging portion 114 away from the second engaging portion 116 of the second holding part 106 so that the operating element 210 is released for movement relative to the first holding part 104 and the second holding part 106. In the release state, sliding movement of the operating element 210 through the casing 102 is allowed so that the anchor device 100 does not move along with the operating element 210. For example, the operating element 210 may move along the passage 108 through the casing 102 in sliding contact with the first engaging portion 114 of the first holding part 104 and out of contact with the second engaging portion 116 of the second holding part 106.

In the illustrated embodiment, the first holding part 104 is configured to slide relative to the casing 102 and the second holding part 106 between the hold state and the release state. For example, the first holding part 104 can include a rod portion 120, and the casing wall 118 can have a guide structure 122 connected to the rod portion 120 such that the first holding part 104 can slide parallel to the casing wall 118 along an axis Y. The guide structure 122 may exemplarily include protruding ribs adapted to guide the rod portion 120 of the first holding part 104 for sliding movements along the axis Y. Alternatively or in addition the aforementioned features, a guide structure may include a guide slot (not shown) that is provided in one of the casing 102 and the rod portion 120 and extends along the axis Y, and a protrusion (not shown) that is coupled to the other one of the casing 102 and the rod portion 120 and is slidably connected to the guide slot. It will be understood that the first holding part 104 is not limited to the above examples and may be coupled to the casing 102 via any suitable sliding connections.

Referring to FIGS. 2-4, the first engaging portion 114 of the first holding part 104 can be provided at an end of the rod portion 120 and can have a convex shape adapted to be in sliding contact with the operating element 210. According to an example of construction, the first holding part 104 comprised of the first engaging portion 114 and the rod portion 120 may be formed integrally as a single piece. In another example of construction, the first engaging portion 114 may be a separate piece fastened to the rod portion 120. The operating element 210 extends along the passage 108 in a region between the two openings 108A and 108B of the casing 102, and wraps at least partially around the first engaging portion 114. As shown in FIG. 3, the operating element 210 can exemplarily form a shape similar to a parabola wrapping around the first engaging portion 114. When the first holding part 104 is in the release state, the operating element 210 may be in sliding contact with the first engaging portion 114. As the first holding part 104 slides toward the hold state, the first engaging portion 114 is displaced along the axis Y toward the second engaging portion 116 of the second holding part 106. The operating element 210 can be thereby urged by the first engaging portion 114 of the first holding part 104 against the second engaging portion 116 of the second holding part 106.

Referring to FIGS. 2 and 3, the anchor device 100 may further include an elastic element 124 configured to bias the first holding part 104 toward the hold state. According to an example of construction, the elastic element 124 can include a spring connected to the casing 102 and the first holding part 104. For example, the rod portion 120 of the first holding part 104 can have a cavity 126, and the resilient element 124 may be disposed at least partially inside the cavity 126 and have two ends respectively connected to the casing 102 and the rod portion 120.

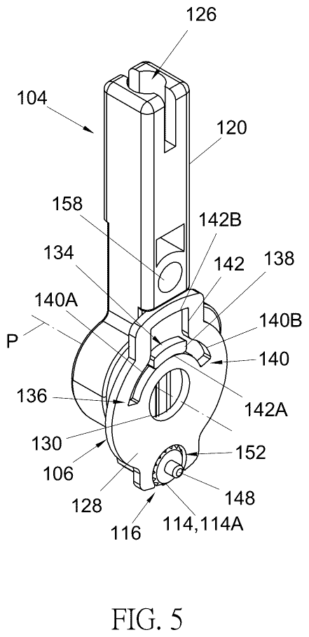

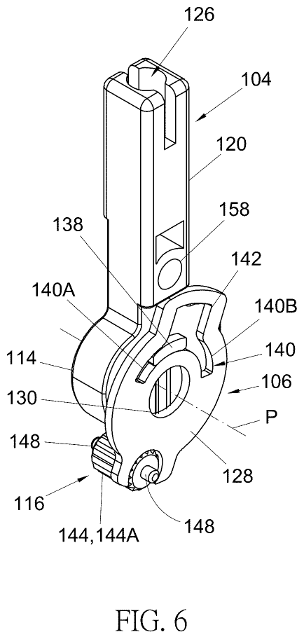

In conjunction with FIGS. 2 and 3, FIGS. 5 and 6 are two perspective views illustrating some construction details of the first holding part 104 and the second holding part 106. Referring to FIGS. 2, 3, 5 and 6, the second holding part 106 is configured to be movable relative to the casing 102 and the first holding part 104 between an unlocking position and a locking position. FIG. 5 shows the second holding part 106 in the unlocking position, and FIG. 6 shows the second holding part 106 in the locking position.

The second holding part 106 is movable relative to the casing 102 and the first holding part 104 from the unlocking position to the locking position to lock the first holding part 104 in the hold state. When the second holding part 106 is in the locking position, the first holding part 104 is prevented from moving from the hold state to the release state. This can ensure that the first and the second engaging portions 114 and 116 of the first and the second holding parts 104 and 106 are kept securely engaged with the operating element 210 to prevent sliding of the operating element 210 through the anchor device 100.

The second holding part 106 is movable relative to the casing 102 and the first holding part 104 from the locking position to the unlocking position to release the first holding part 104. While the second holding part 106 is in the unlocking position, the first holding part 104 is allowed to transition between the hold state and the release state.

Referring to FIGS. 2-6, the second holding part 106 can include a support element 128 connected to the casing 102, and the second engaging portion 116 is coupled to the support element 128 so that both the second engaging portion 116 and the support element 128 move concurrently relative to the casing 102.

According to an embodiment, the second holding part 106 is configured to rotate relative to the casing 102 and the first holding part 104 between the unlocking position and the locking position. For example, the support element 128 can be pivotally connected to the casing 102 about a pivot axis P. The second engaging portion 116 of the second holding part 106 can be coupled to the support element 128 at a location distant from the pivot axis P. For a compact assembly, the support element 128 may be disposed between the first holding part 104 and the casing wall 118. According to an example of construction, the support element 128 may be in the form of a plate. It will be appreciated, however, that the support element 128 may have any suitable shapes or structures. The support element 128 can have an opening 130, and the casing wall 118 can have a protrusion 132 extending along the pivot axis P and disposed through the opening 130 for pivotally connecting the support element 128 about the pivot axis P. Alternatively, the pivot connection may be achieved by interchanging the opening 130 and the protrusion 132, i.e., the opening may be provided on the casing wall 118 and the protrusion may be provided on the support element 128 of the second holding part 106. The second holding part 106 can thereby rotate about the pivot axis P parallel to the casing wall 118.

Referring to FIGS. 2, 5 and 6, the first holding part 104 is kept in the hold state through a locking mechanism including a first latching portion 134 and a second latching portion 136 respectively provided on the first holding part 104 and the second holding part 106, wherein the second latching portion 136 is disengaged from the first latching portion 134 in the unlocking position and engaged with the first latching portion 134 in the locking position. The first latching portion 134 can move along with the first holding part 104 between the hold state and the release state, and the second latching portion 136 can move along with the second holding part 106 between the unlocking position and the locking position.

According to an embodiment, one of the first latching portion 134 and the second latching portion 136 can include a locking slot connected to a clearance, and the other one of the first latching portion 134 and the second latching portion 136 can include a protrusion adapted to engage and disengage the locking slot as desired. In the illustrated example, the first latching portion 134 can include a protrusion 138 provided on the first holding part 104, and the second latching portion 136 can include a locking slot 140 provided in the support element 128 of the second holding part 106. The locking slot 140 can be connected to a clearance 142 provided in the support element 128. The clearance 142 can be formed as a cavity inside the support element 128. The locking slot 140 can extend transversally relative to the clearance 142.

While the second holding part 106 is in the unlocking position, the first holding part 104 is movable relative to the second holding part 106 between the release state and the hold state. As the first holding part 104 moves between the release state and the hold state, the protrusion 138 is located outside the locking slot 140 and moves inside the clearance 142 of the support element 128 along the axis Y.

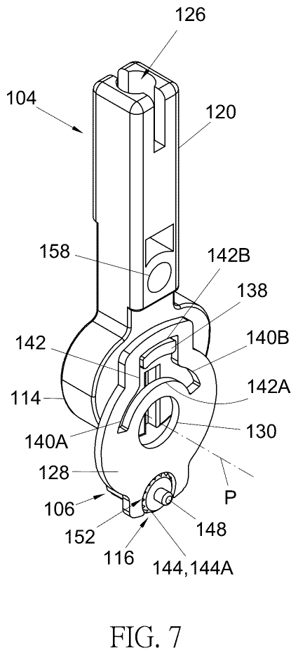

FIG. 5 shows the second holding part 106 in the unlocking position and the first holding part 104 in the hold state, wherein the protrusion 138 is adjacent to an end 142A of the clearance 142. FIG. 7 shows the second holding part 106 in the unlocking position and the first holding part 104 in the release state, wherein the protrusion 138 is displaced to be adjacent to another opposite end 142B of the clearance 142. According to an example of construction, the two opposite ends 142A and 142B of the clearance 142 may be used to delimit a course of the first holding part 104 between the hold state and the release state.

While the first holding part 104 is in the hold state, the second holding part 106 can move from the unlocking position to the locking position and cause the protrusion 138 to move from the clearance 142 into the locking slot 140. For example, the second holding part 106 can rotate about the pivot axis P to cause the protrusion 138 to move into the locking slot 140 and thereby lock the first holding part 104 in the hold state.

According to an example of construction, the locking slot 140 can include two slot portions 140A and 140B respectively provided at two opposite sides of the clearance 142, and the second holding part 106 can rotate in either direction to transition from the unlocking position to the locking position. For example, the second holding part 106 can rotate in a first direction to cause the protrusion 138 to move from the clearance 142 into the slot portion 140A of the locking slot 140 to lock the first holding part 104 in the hold state, or can rotate in a second direction opposite to the first direction to cause the protrusion 138 to move from the clearance 142 into the slot portion 140B of the locking slot 140 to likewise lock the first holding part 104 in the hold state. The second holding part 106 thus can have two locking positions respectively provided at two opposite sides of the unlocking position. The two outermost ends of the slot portions 140A and 140B may be used to delimit a range of rotation of the second holding part 106 relative to the first holding part 104.

The foregoing has described an example in which the protrusion 138 is provided on the first holding part 104, and the locking slot 140 and the clearance 142 are provided in the support element 128 of the second holding part 106. It will be appreciated that the locking mechanism may also be achieved by interchanging the positions of these elements, i.e., the protrusion 138 may be provided on the support element 128 of the second holding part 106, and the locking slot 140 and the clearance 142 may be arranged in the first holding part 104.

Referring to FIGS. 2, 3, 5 and 6, while the first holding part 104 is in the hold state, the second engaging portion 116 of the second holding part 106 can be configured such that the operating element 210 engaged with the second engaging portion 116 is operable to cause the second holding part 106 to move between the unlocking position and the locking position. Various constructions may be applied for the second engaging portion 116 as described hereinafter.

According to an embodiment, the second engaging portion 116 can include a toothed element 144 adapted to engage with the operating element 210. The toothed element 144 can include one tooth or a plurality of teeth that can facilitate an engagement between the second engaging portion 116 of the second holding part 106 and the operating element 210.

In the example of FIGS. 2-6, the toothed element 144 can be a toothed roller 144A movably coupled to the support element 128. The toothed roller 144A can be particularly adapted to engage with a cord loop provided as the operating element 210. The toothed roller 144A can be disposed at a location distant from the pivot axis P, and can be engaged with a toothed track 146 provided in the casing 102. According to an example of construction, the toothed track 146 can extend between the casing wall 118 and a restricting piece 150A fixedly connected to the casing 102, the toothed roller 144A can be disposed between the casing wall 118 and the restricting piece 150A and can have two opposite end shafts 148 respectively connected slidably to the restricting piece 150A and a guide slot 150B arranged in the casing wall 118. An upper edge of the restricting piece 150A and the guide slot 150B can have an arcuate shape corresponding to an arcuate shape of the toothed track 146. The two end shafts 148 can be guided to slide along the upper edge of the restricting piece 150A and the guide slot 150B as the toothed roller 144A rotates about the axis of the end shafts 148 and rolls along the toothed track 146. While the operating element 210 is engaged with the toothed roller 144A, which occurs when the first holding part 104 is in the hold state, the operating element 210 may be selectively operated in either of two opposite directions D1 and D2, which can displace the toothed roller 144A along the toothed track 146 and cause the second holding part 106 to transition between the unlocking position and the locking position.

As shown in FIGS. 2-6, the toothed roller 144A can be exemplarily coupled to the support element 128 at a location opposite to the clearance 142 relative to the pivot axis P of the support element 128. For example, the support element 128 can have a notch 152, and the toothed roller 144A can be at least partially received in the notch 152. A displacement of the toothed roller 144A along the toothed track 146 thus can be linked to a rotation of the support element 128 about the pivot axis P. The support element 128 can rotate about the pivot axis P while the toothed roller 144A concurrently moves along the toothed track 146.

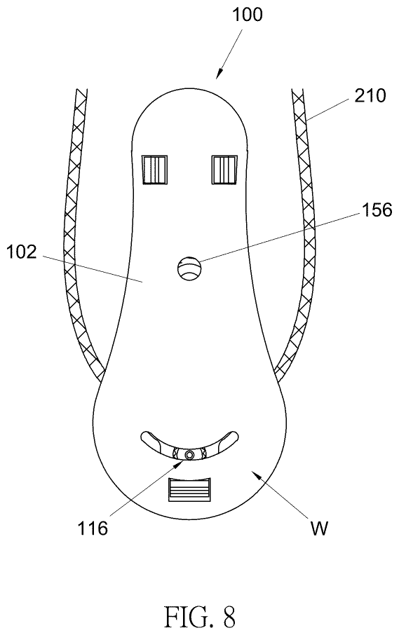

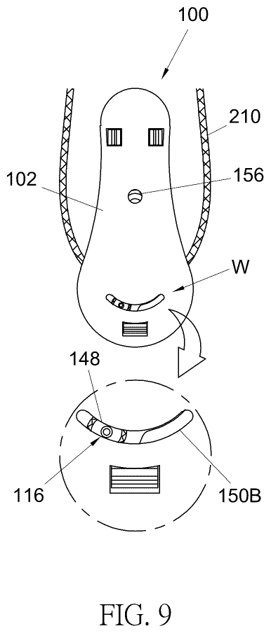

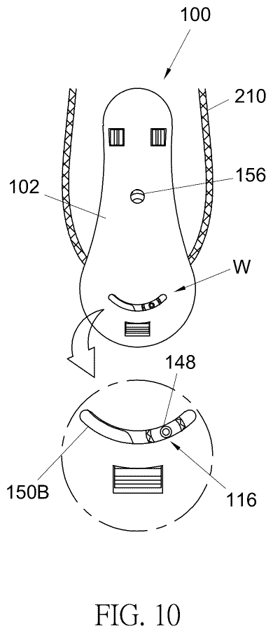

In conjunction with FIGS. 1 and 2, FIGS. 8-10 are rear views of the anchor device 100. Referring to FIGS. 1, 2 and 8-10, the position of the toothed roller 144A and the end shafts 148 thereof, which corresponds to the position of the second engaging portion 116 of the second holding part 106, can be directly observable by a user through a window W provided on the casing 102. The window W is exemplary provided on the casing wall 118 corresponding to the region of the guide slot 150B. A central position of the second engaging portion 116 (shown in FIG. 8) can correspond to the unlocking position of the second holding part 106, and a sideways displaced position (shown in FIGS. 9 and 10) relative to the central position can correspond to the locking position of the second holding part 106. A user thus can visually check the actual position of the second holding part 106.

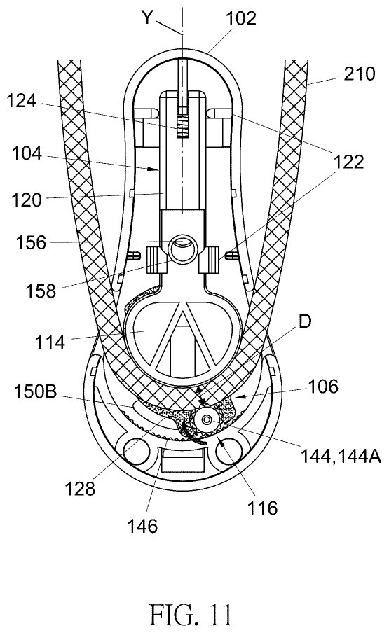

Referring to FIGS. 2-6, while the first engaging portion 114 and the second engaging portion 116 are engaged with the operating element 210, the second holding part 106 is movable relative to the first holding part 104 to displace the second engaging portion 116 for pressing the operating element 210 against the first engaging portion 114. For example, while the first holding part 104 is in the hold state, the operating element 210 engaged with the second engaging portion 116 can be operated to displace the second engaging portion 116 so that the second engaging portion 116 presses the operating element 210 against the first engaging portion 114. FIG. 11 illustrates an example of displacement of the second engaging portion 116 for pressing the operating element 210 against the first engaging portion 114.

The second engaging portion 116 moves along a travel path during movement of the second holding part 106. In the example of FIGS. 2-11, the travel path of the second engaging portion 116 corresponds to an arc centered on the pivot axis P of the support element 128. The travel path of the second engaging portion 116 can be configured such that a distance D between the first engaging portion 114 of the first holding part 104 and the second engaging portion 116 of the second holding part 106 is reduced as the second holding part 106 moves from a first position (e.g., the position shown in FIG. 3) to a second position (e.g., the position shown in FIG. 11). The distance D can be exemplarily taken between two opposite outer surfaces of the first and the second engaging portions 114 and 116 that are in contact with the operating element 210. Since the distance D is smaller in the second position than in the first position, the pressure applied by the second engaging portion 116 upon the operating element 210 is greater in the second position than in the first position. While the first holding part 104 is in the hold state, the operating element 210 engaged with the second engaging portion 116 is thus operable to cause the second engaging portion 116 to move for further pressing the operating element 210 against the first engaging portion 114.

According to an example of construction, the distance D between the first engaging portion 114 of the first holding part 104 and the second engaging portion 116 of the second holding part 106 can be reduced as the second holding part 106 moves from the unlocking position to the locking position. Accordingly, the second engaging portion 116 can move for pressing the operating element 210 against the first engaging portion 114 as the second holding part 106 transitions from the unlocking position to the locking position.

It will be appreciated that the second holding part 106 is not limited to the aforementioned constructions. For instance, rather than pivotally connecting the support element 128 of the second holding part 106 to the casing 102, another construction may have the support element slidably connected to the casing so that the support element is slidable transversally relative to the axis Y (shown in FIG. 2). Such a support element can likewise include a locking slot and a clearance (similar to the locking slot 140 and the clearance 142 described previously) for locking the first holding part in the hold state, and can be provided with a second engaging portion including a toothed element adapted to engage with the operating element 210. The travel path of the second engaging portion coupled to the sliding support element can also be arranged such that a distance between the first engaging portion of the first holding part and the second engaging portion of the second holding part is reduced as the second holding part moves from the unlocking position to the locking position. In this manner, the operating element engaged with the second engaging portion can move to likewise cause the second holding part to transition between the unlocking position and the locking position, and cause the second engaging portion to move for pressing the operating element against the first engaging portion as the second holding part transitions from the unlocking position to the locking position.

Referring to FIG. 2, a fixing part 154 can be provided to affix the anchor device 100 to a support surface, e.g., on a wall of a house. Examples of construction for the fixing part 154 may include, without limitation, a fastener (such as a screw), a mount backet, and the like. The fixing part 154 can engage through the casing 102 at any suitable locations to affix the casing 102 to the support surface. According to an example of construction, the fixing part 154 may engage through the casing 102 and the first holding part 104. This may assist in locking the first holding part 104 in position (i.e., corresponding to the release state) when the anchor device 100 is affixed to the support surface. According to another example of construction, the fixing part 154 may engage through the casing 102 at a location apart from the first holding part 104.

In the example of FIG. 2, the fixing part 154 can engage through a hole 156 provided in the casing 102, wherein the hole 156 can exemplarily extend through the casing body 110 (e.g., the casing wall 118) and the cover 112 of the casing 102. The first holding part 104 can also include a hole 158, which is aligned with the hole 156 of the casing 102 when the first holding part 104 is in the release state and misaligned with the hole 156 of the casing 102 when the first holding part 104 is in the hold state. When the first holding part 104 is in the hold state, the hole 156 of the casing 102 may be at least partially obstructed by the first holding part 104 so that the fixing part 154 cannot be properly engaged through the casing 102 for affixing the anchor device 100 to the support surface. For affixing the anchor device 100 to the support surface, the first holding part 104 is first positioned in the release state, and the fixing part 154 is then engaged through the hole 156 of the casing 102 and the hole 158 of the first holding part 104.

In the example of FIG. 2, the fixing part 154 includes a screw 160 that can be disposed through the hole 156 of the casing 102 and the hole 158 of the first holding part 104 and engage with the support surface for affixing the anchor device 100.

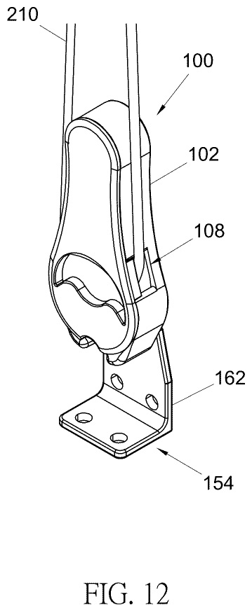

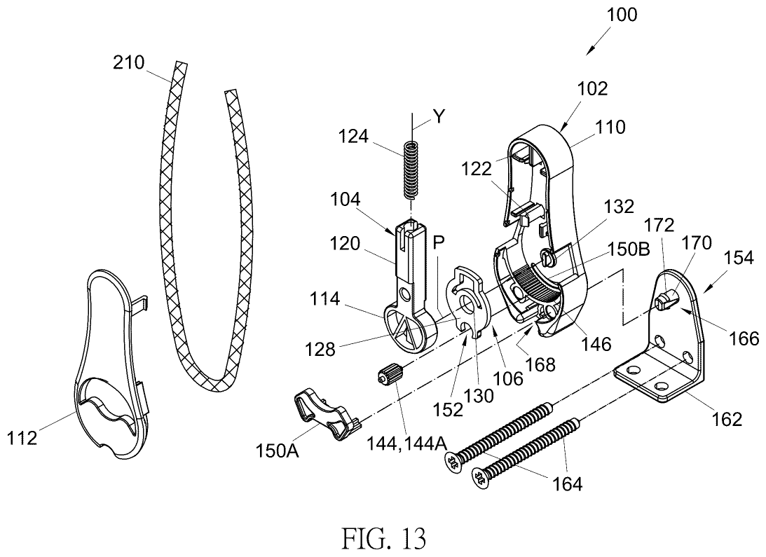

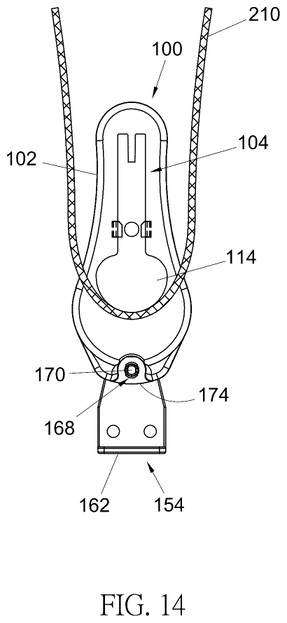

FIGS. 12-14 are schematic views illustrating another construction in which the fixing part 154 includes a mount bracket 162 and one or more fasteners 164. The mount bracket 162 is attachable to a support surface via the fasteners 164, and has a protruding structure 166 adapted to engage through a hole 168 provided in the casing 102. As shown in FIGS. 12 and 13, the mount bracket 162 may exemplarily have a L-shape. It will be appreciated, however, that the mount bracket 162 may have any suitable shapes that can be attached to a support surface. The protruding structure 166 can include a post 170 provided with one or more flange 172 protruding sideways from the post 170.

The hole 168 can be provided in the casing 102 at a location apart from the first holding part 104. For example, the casing body 110 can have a lug 174 at a peripheral location, and the hole 168 can be provided in the lug 174. The post 170 of the mount bracket 162 can be engaged through the hole 168 so that the lug 174 is restrictedly positioned between the flange 172 and the mount bracket 162. The casing 102 of the anchor device 100 can be thereby attached to the mount bracket 162.

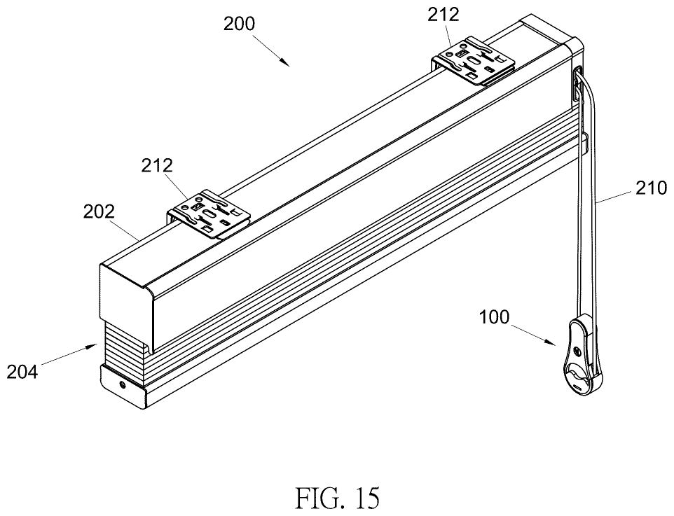

In conjunction with FIGS. 1-11, FIG. 15 is a perspective view illustrating exemplary use of the anchor device 100 with a window shade 200. The window shade 200 can include a head rail 202, a shading structure 204 suspended from the head rail 202, and an actuating system including the operating element 210 coupled to the anchor device 100, wherein the operating element 210 is operable to control an extension of the shading structure 204 relative to the head rail 202. The head rail 202 may be affixed at a top of a window frame via a plurality of attaching brackets 212. The shading structure 204 may have any suitable structure that can be extended from or retracted toward the head rail 202. In the illustrated example, the shading structure 204 has a cellular structure. Other constructions for the shading structure 204 may include, without limitation, a panel assembly, slats, etc. The actuating system of the window shade 200 is mounted to the head rail 202, and the operating element 210 extends outward from the head rail 202. In the illustrated example of FIG. 15, the operating element 210 is a cord loop and is threaded through the anchor device 100.

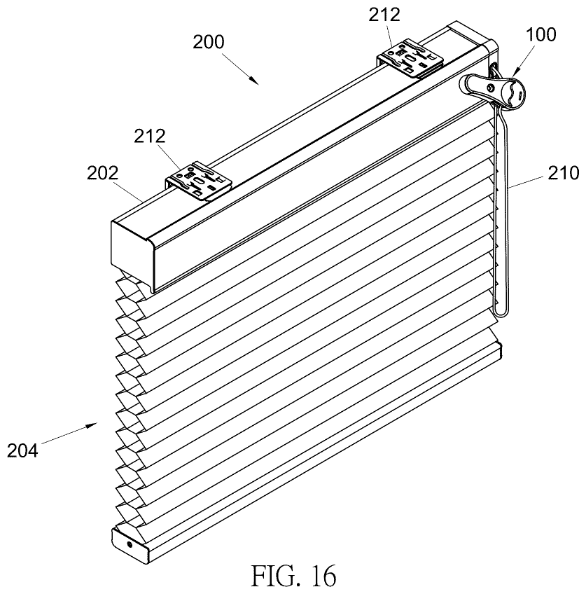

In conjunction with FIG. 15, FIG. 16 is a perspective view illustrating exemplary operation of the window shade 200 while the anchor device 100 is not affixed to a fixed support surface. In FIG. 15, the shading structure 204 of the window shade 200 is shown in a retracted state, and the anchor device 100 is appended to the operating element 210 distant from the head rail 202. Referring to FIGS. 1-11 and 15, supposing that the anchor device 100 is not affixed to a fixed support surface, the first holding part 104 is biased by the elastic element 124 to the hold state so that both the first engaging portion 114 of the first holding part 104 and the second engaging portion 116 of the second holding part 106 are engaged with the operating element 210. Accordingly, the anchor device 100 holds on to the operating element 210.

Referring to FIGS. 1-11 and 16, while the anchor device 100 is not affixed to a fixed support surface, pulling the operating element 210 in one direction (e.g., for expanding the shading structure 204) will cause the anchor device 100 to move along with the operating element 210 and rise until the anchor device 100 abuts against the head rail 202. Once the anchor device 100 is stopped by the head rail 202, a further pulling of the operating element 210 in the same direction would cause the second holding part 106 to transition to the locking position so that the first holding part 104 is locked in the hold state. Moreover, the second engaging portion 116 of the second holding part 106 would further press the operating element 210 against the first engaging portion 114 of the first holding part 104. Since the anchor device 100 tightly holds on to the operating element 210 and is stopped by the head rail 202, the operating element 210 cannot continue moving in the same pulling direction. The abutment of the anchor device 100 against the head rail 202 thus can hamper normal operation of the window shade 200.

For a proper operation, the anchor device 100 has to be affixed at a suitable position on a fixed support surface. For example, the operating element 210 may be operated so as to displace the anchor device 100 held therewith away from the head rail 202. Before attaching the anchor device 100 to the support surface, a user can check through the window W whether the second holding part 106 is in the unlocking position. If the second holding part 106 is in the locking position, the operating element 210 can be operated to urge the second holding part 106 to move from the locking position to the unlocking position.

While the second holding part 106 is in the unlocking position, the anchor device 100 can be displaced in a direction opposite the operating element 210 so that the operating element 210 is tensioned and urges the first holding part 104 to transition from the hold state to the release state. The fixing part 154 then can be engaged through the casing 102 to affix the anchor device 100 to the support surface.

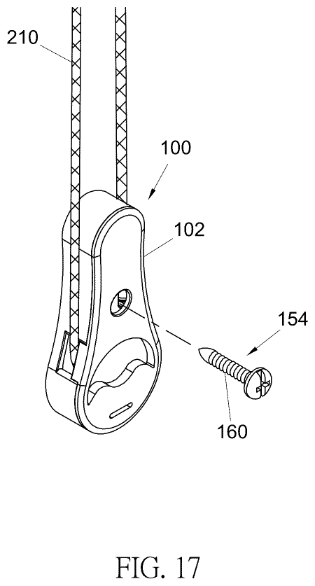

With respect to the example of FIG. 2, the anchor device 100 can be affixed to the support surface with the screw 160 engaged through the casing 102 and the first holding part 104 in the release state. This is illustrated in FIG. 17.

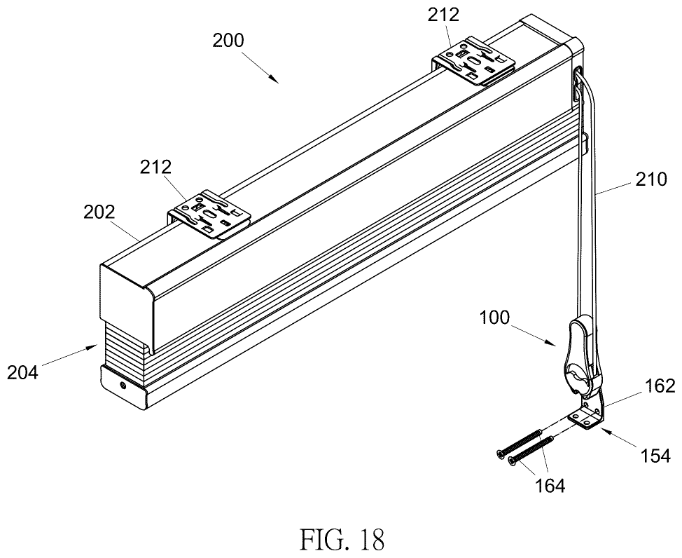

With respect to the example shown in FIG. 13, the anchor device 100 can be affixed to the support surface by engaging the protruding structure 166 of the mount bracket 162 with the casing 102 of the anchor device 100 and by affixing the mount bracket 162 to the support surface with the fasteners 164. This is illustrated in FIG. 18.

Once the anchor device 100 is affixed to the support surface, the first holding part 104 is maintained in the release state to allow free travel of the operating element 210 through the anchor device 100. Accordingly, the operating element 210 can be operated to expand or retract the shading structure 204 as desired.

Although the foregoing has described embodiments in which the operating element 210 of the window shade 200 is a cord loop, it will be appreciated that the cord loop may be replaced with a bead chain.

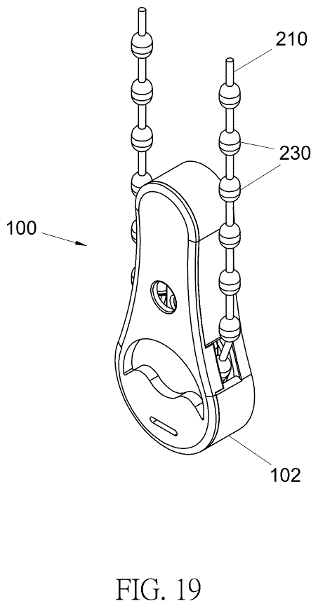

FIGS. 19-25 are schematic views illustrating a variant embodiment of the anchor device 100 for an operating element 210 of a window shade, wherein the operating element 210 is a bead chain including a string of beads 230. Referring to FIGS. 19-25, the anchor device 100 can have a same construction as the previous embodiment, a difference is that the toothed element 144 is fixedly connected to the support element 128. The toothed element 144 is disposed on the support element 128 at a location distant from the pivot axis P thereof, and can have any shape adapted to insert into a gap between two adjacent beads 230 of the bead chain. In the illustrated example, the toothed element 144 includes a tooth 144B that substitutes for the toothed roller 144A of the previous embodiment. According to an example of construction, the toothed element 144 including the tooth 144B can be formed integrally with the support element 128. Alternatively, the toothed element 144 may be provided as a separate piece fastened to the support element 128. The tooth 144B protrudes from the support element 128 in a direction transversal to the operating element 210, and is dimensioned so as to be able to engage and disengage a gap between two adjacent beads 230.

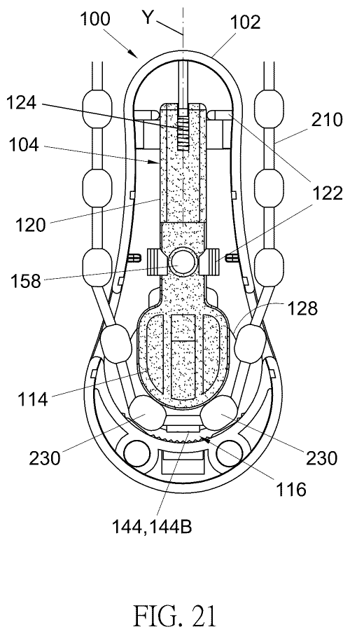

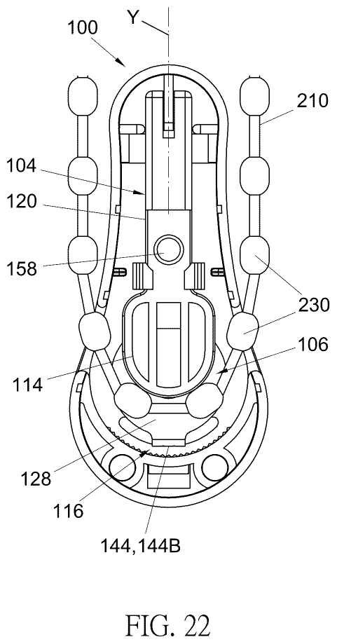

FIGS. 21 and 22 respectively show the first holding part 104 in the hold state and the release state. Like in the previous embodiment, the first holding part 104 can slide along the axis Y between the hold state and the release state, wherein the operating element 210 is engaged with the first engaging portion 114 of the first holding part 104 and the second engaging portion 116 of the second holding part 106 in the hold state, and the operating element 210 is disengaged from the second engaging portion 116 of the second holding part 106 in the release state. In particular, the tooth 144B is received in the gap between two adjacent beads 230 when the second engaging portion 116 of the second holding part 106 is engaged with the operating element 210, and is located outside the gap between the two adjacent beads 230 when the second engaging portion 116 is disengaged from the operating element 210.

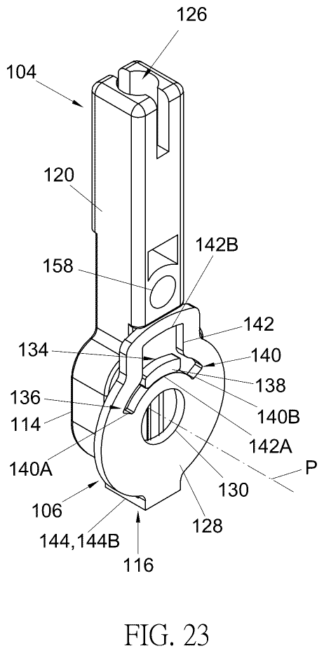

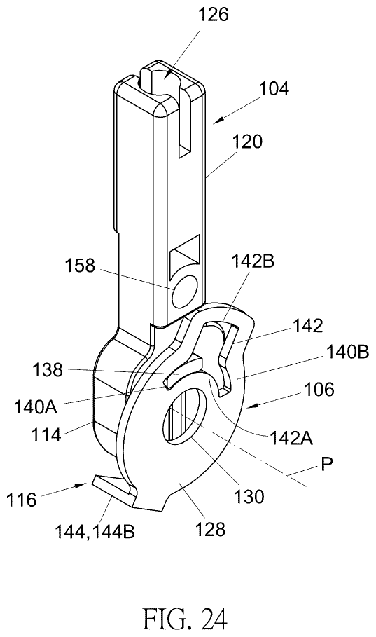

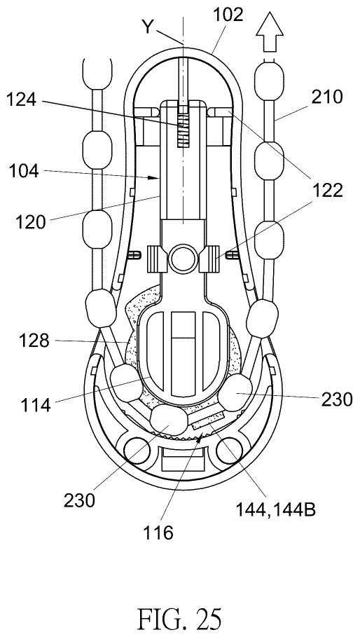

FIG. 23 shows the second holding part 106 in the unlocking position, and FIGS. 24 and 25 show the second holding part 106 in the locking position. Like in the previous embodiment, the second holding part 106 is movable relative to the casing 102 and the first holding part 104 between the unlocking position and the locking position. While the first holding part 104 is in the hold state, the engagement of the toothed element 144 can couple the operating element 210 to the second holding part 106 so that the operating element 210 and the second holding part 106 can move concurrently relative to the first holding part 104. Accordingly, like in the previous embodiment, the operating element 210 engaged with the second engaging portion 116 is operable to cause the second holding part 106 to move between the unlocking position and the locking position.

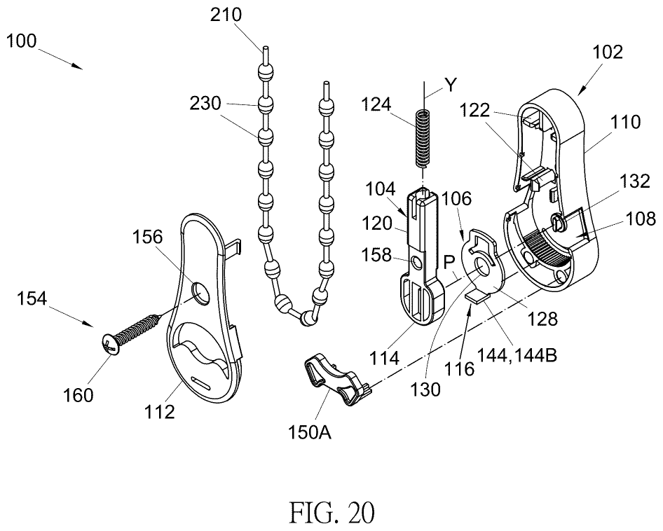

Referring to FIG. 20, the fixing part 154 of the anchor device 100 can include the screw 160 which can be engaged through the hole 156 of the casing 102 and the hole 158 of the first holding part 104 for affixing the anchor device 100 to a support surface.

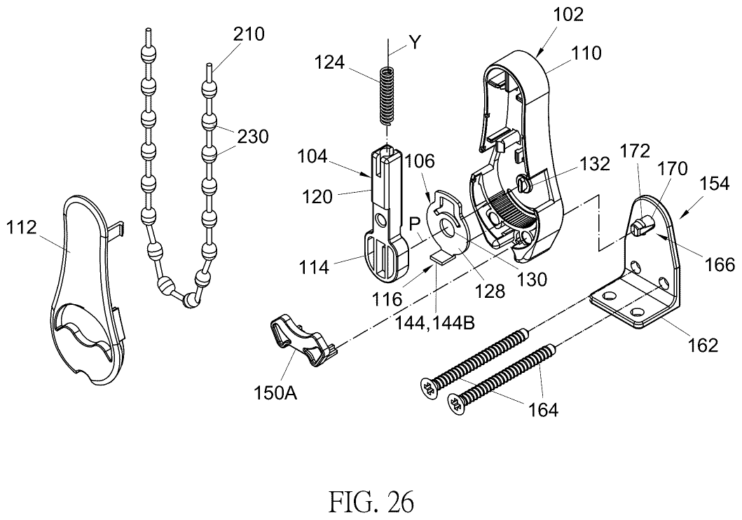

It will be appreciated that the fixing part 154 of the embodiment shown in FIGS. 19-25 may also be replaced with the fixing part 154 shown in FIG. 26, which has the same construction comprised of the mount bracket 162 and the fasteners 164 described previously with reference to FIGS. 12-14. Like previously described, the mount bracket 162 can be attached to the support surface via the fasteners 164. The post 170 of the mount bracket 162 can be engaged through the hole 168 in the lug 174 of the casing 102 so that the lug 174 is restrictedly positioned between the catch portion 172 and the mount bracket 162. The casing 102 of the anchor device 100 can be thereby secured to the mount bracket 162.

Although FIGS. 20 and 26 may show that the casing 102 has a toothed track similar to the toothed track 146 shown in FIG. 2, it will be appreciated that the shown toothed track is not mandatory and may be omitted as the toothed element 144 of FIGS. 20 and 26 do not use the toothed roller 144A. Moreover, the embodiments of FIGS. 20 and 26 may keep the restricting piece 150A, which may assist in positioning the operating element 210 relative to the toothed element 144. Aside the difference in the configuration of the toothed element 144, the remaining elements of the anchor device 100 shown in FIGS. 19-26 may have the same construction as the previous embodiment, and the anchor device 100 can be used with the window shade and operate in a similar way.

Advantages of the structures described herein include the ability to provide an anchor that is simple in construction and can ensure that an operating element of a window shade is properly anchored on a fixed support surface for use. Accordingly, accidental wrapping of the operating element around the neck of a child can be prevented Realization of the structures have been described only in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the claims that follow.

What is claimed is:

1. An anchor device for an operating element of a window shade, comprising:
a casing having a passage of an operating element;
a first holding part movably connected to the casing and having a first engaging portion adapted to engage with the operating element; and
a second holding part movably connected to the casing and having a second engaging portion adapted to engage with the operating element;
wherein the first engaging portion and the second engaging portion are operable to engage with the operating element so that the anchor device holds on to the operating element, and the first engaging portion and the second engaging portion are placed away from each other to release the operating element for movement of the operating element through the anchor device.

2. The anchor device according to claim 1, wherein the casing has a casing wall delimiting at least partially a hollow interior of the casing, the first holding part and the second holding part are disposed in the hollow interior and are movable parallel to the casing wall.

3. The anchor device according to claim 1, wherein the first holding part is movable from a release state to a hold state to urge a portion of the operating element against the second engaging portion of the second holding part so that the operating element is engaged with the first engaging portion and the second engaging portion, and the second holding part is movable from an unlocking position to a locking position to lock the first holding part in the hold state.

4. The anchor device according to claim 3, wherein while the first holding part is in the hold state, the second engaging portion of the second holding part is configured such that the operating element engaged with the second engaging portion is operable to cause the second holding part to move between the unlocking position and the locking position.

5. The anchor device according to claim 3, wherein the first holding part is configured to slide between the hold state and the release state.

6. The anchor device according to claim 3, wherein the second holding part is configured to rotate between the unlocking position and the locking position.

7. The anchor device according to claim 3, wherein the first holding part is kept in the hold state through a locking mechanism including a first latching portion and a second latching portion respectively provided on the first holding part and the second holding part, the second latching portion being disengaged from the first latching portion in the unlocking position and engaged with the first latching portion in the locking position.

8. The anchor device according to claim 7, wherein one of the first latching portion and the second latching portion includes a locking slot connected to a clearance, and the other one of the first latching portion and the second latching portion includes a protrusion adapted to engage and disengage the locking slot.

9. The anchor device according to claim 8, wherein the protrusion is movable inside the clearance as the first holding part moves between the release state and the hold state, and the second holding part being movable to cause the protrusion to move from the clearance into the locking slot while the first holding part is in the hold state.

10. The anchor device according to claim 8, wherein the locking slot includes two slot portions respectively provided at two opposite sides of the clearance.

11. The anchor device according to claim 3, wherein a distance between the first engaging portion of the first holding part and the second engaging portion of the second holding part is reduced as the second holding part moves from the unlocking position to the locking position.

12. The anchor device according to claim 1, wherein the second engaging portion includes a toothed element adapted to engage with the operating element.

13. The anchor device according to claim 1, wherein the second holding part includes a support element pivotally connected to the casing about a pivot axis, and the second engaging portion is coupled to the support element at a location distant from the pivot axis and includes a toothed element adapted to engage with the operating element.

14. The anchor device according to claim 1, wherein while the first engaging portion and the second engaging portion are engaged with the operating element, the second holding part is movable relative to the first holding part to displace the second engaging portion for pressing the operating element against the first engaging portion.

15. The anchor device according to claim 13, wherein:
the toothed element is a toothed roller movably coupled to the support element; or
the toothed element is fixedly connected to the support element.

16. The anchor device according to claim 15, wherein:
the toothed roller is engaged with a toothed track provided in the casing and is used as the toothed element when the operating element is a cord loop; and
the toothed element is fixedly connected to the support element when the operating element is a bead chain, the toothed element fixedly connected to the support element having a shape adapted to insert into a gap between two adjacent beads of the bead chain.

17. The anchor device according to claim 3, further comprising an elastic element configured to bias the first holding part toward the hold state.

18. The anchor device according to claim 1, further comprising a fixing part for affixing the anchor device to a support surface, wherein the fixing part engages through the casing and the first holding part, or the fixing part engages through the casing at a location apart from the first holding part.

19. The anchor device according to claim 18, wherein the casing has a hole, and the fixing part includes a mount bracket attachable to the support surface via one or more fastener and having a protruding structure adapted to engage through the hole in the casing.

20. A window shade comprising:
a shading structure;
an operating element operable to control an extension of the shading structure; and
the anchor device according to claim 1, being coupled to the operating element.
